(19) United States
(12) Patent Application Publication
(10) Pub. No.: US 2022/0034644 A1
(43) Pub. Date: Feb. 3, 2022

(54) ROTATION ANGLE SENSOR HAVING TWO SENSOR SIGNALS AND OPERATING METHOD

(71) Applicant: ZF Friedrichshafen AG, Friendrichshafen (DE)

(72) Inventors: Manuel KWANDT, Espelkamp (DE); Jürgen GRIES, Lage (DE)

(73) Assignee: ZF Friedrichshafen AG, Friendrichshafen (DE)

(21) Appl. No.: 17/298,465

(22) PCT Filed: Nov. 27, 2019
(86) PCT No.: PCT/EP2019/082742

§ 371 Date: May 28, 2021

(30) Foreign Application Priority Data
Nov. 30, 2018 (DE) 10 2018 220 667.8

(51) Int. Cl. G01B 7/30; G01D 5/14

(52) U.S. Cl. CPC G01B 7/30; G01D 5/145

(57) ABSTRACT

The invention relates to a sensor arrangement for determining a rotation angle of a diametrically magnetized magnet about a rotation axis relative to a main support, containing two sensors at different circumferential positions having a radial distance to the rotation axis in order to detect tangential and axial components of the measurement field of the magnet, and an evaluating unit for determining the rotation angle from the components based on an arctangent function. In a method for determining the rotation angle, the components are detected by the sensors and the rotation angle is determined therefrom based on an arctangent function.

The invention relates to a sensor arrangement for determining a rotation angle of a magnet about an axis of rotation relative to a base carrier, and to a method for determining the rotation angle of the magnet about the axis of rotation relative to the base carrier in the sensor arrangement.

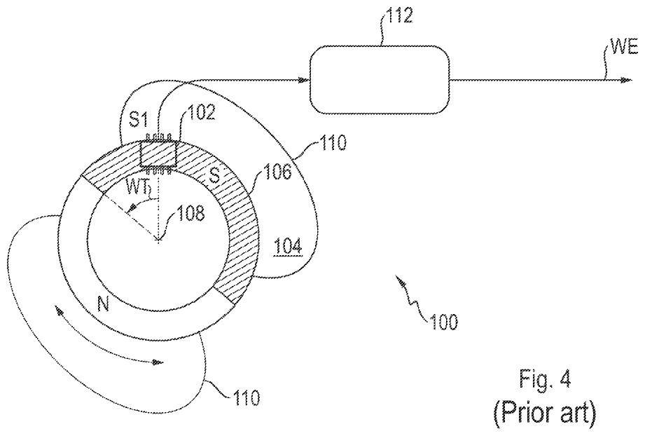

FIG. 4 shows such a sensor arrangement 100 which is known from practice. A sensor 102 is arranged in a positionally fixed fashion on a base carrier 104. A magnet 106 is mounted so as to be rotatable about an axis of rotation 108 relative to the base carrier 104 (indicated by a double arrow) and generates a magnetic measuring field 110 (indicated only symbolically). The magnet 106 assumes here an (actual) rotation angle WT about the axis of rotation 108. The sensor 102 captures the measuring field 110 and the sensor arrangement 100 determines the current (determined) rotation angle WE of the sensor by means of an arc tangent function using an evaluation unit 112.

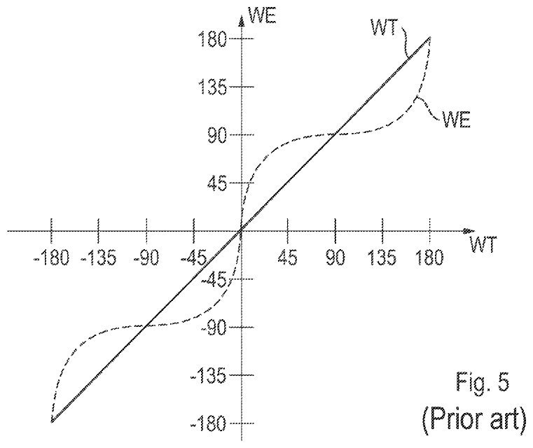

FIG. 5 shows, plotted against the actual rotation angle WT, the rotation angle WE which is determined by means of the arc tangent function. Ideally, the determined rotation angle WE should be equal to the actual rotation angle WT. In practice, the determined rotation angle WE is, however, subject to errors.

The object of the invention is to specify improvements with respect to rotation angle capture.

The object is achieved by means of a sensor arrangement as claimed in patent claim 1. Preferred or advantageous embodiments of the invention and of other inventive categories can be found in the further claims, the following description and the appended figures.

The sensor arrangement serves to determine a (determined) rotation angle of a magnet about an axis of rotation. The rotation angle is that of the magnet about the axis of rotation relative to a base carrier. The sensor arrangement contains the base carrier and the magnet. The magnet can rotate relative to the base carrier about the axis of rotation. The magnet is in particular magnetized diametrically with respect to the axis of rotation. The magnet serves to generate a magnetic measuring field, or the magnet generates the measuring field at least while the sensor arrangement is operating. The magnet is, in particular, a permanent magnet.

The sensor arrangement contains a sensor. The sensor is in particular a Hall sensor. The sensor is arranged in a positionally fixed fashion relative to the base carrier. The sensor serves to capture a first tangential component and a first axial component of the measuring field. The corresponding tangential direction and axial direction are to be understood as being with respect to the axis of rotation. The first sensor is arranged at a first circumferential position with respect to the axis of rotation and is at a first radial distance from the axis of rotation here.

The sensor arrangement contains at least one second sensor for capturing a second tangential component and a second axial component of the measuring field, wherein the components are to be understood, as above, as being with respect to the axis of rotation. The second sensor is arranged at a second circumferential position with respect to the axis of rotation and is at a second radial distance from the axis of rotation. The second circumferential position is in particular different from the first circumferential position. As a result, measuring signals which are offset or shifted selectively with respect to the rotation of the magnet in the manner of a phase shift can be generated in the sensors. This shifting can be used later for compensating the non-linearities, as explained below.

The sensor arrangement contains an evaluation unit. The latter serves to determine the rotation angle from the abovementioned components of the measuring field which are captured by the sensors at the location of the sensors. In this context at least one of the captured tangential components and at least one of the captured axial components are used. Furthermore, at least one further tangential component of those captured or at least one of the captured axial components is also used. The determination by means of the evaluation unit on the basis of the at least three specified components is carried out by means of an arc tangent function (atan function).

Therefore, at least the three specified components are used for the calculation. In particular, all the components captured by the sensors are used.

The invention is based on the following observation: if, in the case of a known rotation angle sensor system (sensor arrangement) such as has been mentioned at the beginning with respect to FIG. 4, the sensor is positioned outside the rotational axis (axis of rotation) of the magnet, a nonlinear profile of the sensor signal, as illustrated in FIG. 5, is obtained, plotted against the (actual) rotation angle. The embodiment of the signal nonlinearity is highly dependent on the air gap between the magnet and sensor and on the distance of the sensor from the axis of rotation of the magnet.

The invention is also based on the realization that this nonlinearity could be linearized in the abovementioned conventional procedure by training the magnet sensor system (sensor arrangement) in a production process. This could be achieved e.g. by virtue of the fact that, for the atan calculation, factors (kx, ky) could be assigned to the individual field components (axial/radial/tangential components captured by the sensor, here for example Bx and By) according to the formula

$$a tan ( \frac{B x * k x}{B y * k y} ) .$$

The invention is based on the idea of compensating the geometrically induced nonlinearity in an alternative fashion.

For this purpose, at least two sensors are used, which are optionally or ideally arranged in a manner offset with respect to one another by 60 to 120 degrees, in particular by 80 to 100 degrees, in particular by 90°, on a circle around the axis of rotation underneath or above the magnet (that is to say offset in the axial direction with respect to the axis of rotation).

Optionally, a different angular ratio or different positioning of the sensors on different radii can also be selected. The selected arrangement is dependent on the shape and magnetization of the magnet used and the selected number of sensors.

The arrangement of the sensors is to be selected optionally in such a way that the measured nonlinear angle signals (raw angle, see below) have a virtually axially symmetrical profile in relation to the ideal, linear sensor angle straight line (ideal error-free determined rotation angle plotted against the actual rotation angle) in the working range.

Since the deviation of the sensor signals (raw angles) from the ideal straight line is respectively larger or above the straight line or smaller or below the straight line, the residual error in relation to the ideal linear straight line can be reduced to a minimum by forming mean values of the two sensor signals (raw angles). This method gives rise to a virtually linear sensor signal (determined rotation angle) with a low residual error (with respect to the ideal straight line) in a wide parameter range independently of the various air gaps.

As a result, it is not necessary to intervene in the atan calculation of the sensor signal (raw angle) in order to linearize the angle profile of the sensor output signal (determined rotation angle) for various air gaps and radii. Costly and time-consuming training processes (e.g. end of line) and air-gap-dependent correction measures during ongoing measuring operation are avoided by this. Furthermore, the exact air gap between the sensor and the magnet is often unknown and can only be measured with a high degree of uncertainty. The correction factors for the air gap correction of the sensor characteristic curve which are calculated in advance for this and stored in a table would consequently always only be able to be applied with the inaccuracy of the air gap measurement, which despite a high level of expenditure brings about a significant residual error in the measuring signal. This disadvantage is overcome by this invention.

The present arrangement is therefore particularly suitable for magnet sensor systems in which the sensor lies far outside the axis of rotation of the encoder magnet. This is the case in particular with ring magnets if the inner region of the magnet is used for cable feedthroughs or the like and the sensor is only located underneath the outer region of the magnet on the printed circuit board (base carrier).

The reduction of the nonlinear measuring error by forming mean values of a plurality of sensors is highly dependent on the positioning of the sensors underneath the magnet. Modern magnetic field calculation programs can be used to determine the ideal positions of the sensors which bring about the best possible error compensation over the parameter range.

This method provides a robust, inherently stable measuring signal (determined rotation angle) with few errors over the (actual) rotation angle and air gap, which does not require training or compensation processes during ongoing measuring operation. Therefore, this arrangement is very advantageous for capturing rotation angles with a push and pull function (shifting of the magnet between different axial positions relative to the base carrier or to the sensors) which has to capture the rotation angle of an operator control element at various distances (air gaps) with a minimum error.

Furthermore, the formation of mean values of the measuring signal significantly reduces the interference influence of an external interference field, since the interference field gradient between the adjacent sensors is generally low owing to the relatively large distance between the interference field source and the sensor system.

This arrangement can be used for permanent magnets of any desired shape, but particularly effectively with rotationally symmetrical geometries such as e.g. in the case of ring magnets and round magnets.

The procedure can be used for conventional Hall-based 2-D angle sensors or 3-D sensors.

In one preferred embodiment of the invention, at least one of the sensors is arranged in a manner offset by an axial distance in relation to a central plane, lying transversely with respect to the axis of rotation, of the magnet in the axial direction of the axis of rotation. This applies in particular to all sensors. In particular at least two or all of the sensors are located in a common parallel plane to the central plane with respect to the axis of rotation. In particular there is an air gap between the magnet and a corresponding sensor. This corresponds to the arrangement specified above “underneath or above” the magnet. The invention is particularly suitable for a corresponding arrangement.

In one preferred embodiment of the invention, at least two, in particular all, of the sensors are at the same axial distance and/or the same radial distance from the axis of rotation. This produces symmetrical or regular arrangements for which the invention can be used particularly effectively.

In one preferred embodiment, two of the circumferential positions are offset at right angles to one another. For these two circumferential positions, respective sensor signals which are phase-offset by the corresponding angle, e.g. 90°, are therefore obtained, which brings about particularly simple error compensation by the formation of mean values between the two sensors.

In one preferred embodiment, the magnet is embodied to be rotationally symmetrical with respect to the axis of rotation. This results in particularly similar but phase-offset signals in the sensors.

In one preferred embodiment, the magnet is a ring magnet which is arranged concentrically with respect to the axis of rotation. Said ring magnet therefore has a central opening which can serve in particular as a cable feedthrough. The sensor arrangement can therefore be used particularly favorably in applications which do not discharge very much radially.

In one preferred embodiment, an axial position of the magnet along the axis of rotation is variable with respect to the base carrier. The variation of a corresponding axial position can also be detected by means of the sensors. The sensor arrangement is therefore suitable for detecting axial movements, in particular of the abovementioned push and pull function. The axial positions of the sensors relative to the magnet therefore change uniformly here.

In one preferred embodiment, the evaluation unit contains a raw angle module which is configured to form a raw angle for the respective sensor from a respective axial component and tangential component of the same sensor by means of an arc tangent function, which raw angle can then be processed to form the rotation angle.

The two component signals of a respective sensor are therefore already preprocessed separately per se inside the evaluation unit to form a raw angle, which enables the subsequent further processing of the raw angle in the evaluation unit. Otherwise, reference is made to the statements above with respect to corresponding raw angles.

In one preferred embodiment, the evaluation unit contains a mean value module which is configured to form a mean value from at least two of the axial components and/or tangential components and/or, if present, from determined raw angles, which mean value can then be processed to form the rotation angle. As explained above, the nonlinearities in the raw angles can be compensated particularly easily by correspondingly forming mean values, wherein the nonlinearities are caused by the axial distance between the sensors and the axis of rotation.

The object of the invention is also achieved by means of a method as claimed in patent claim 10 for determining the rotation angle of the magnet about the axis of rotation relative to the base carrier in the sensor arrangement according to the invention. In the method, at least one of the tangential components and at least one of the axial components and at least one further of the tangential components or of the axial components are captured with the sensors, as explained correspondingly above. The rotation angle is determined from at least the captured components (the axial or tangential component depending on the determination) by means of an arc tangent function. This can take place in the evaluation unit of the sensor arrangement. However, it is also alternatively possible to use a reduced sensor arrangement without an evaluation unit in the method. The corresponding evaluation then takes place in an alternative evaluation unit which can also be located outside the sensor arrangement.

The method and at least some of the embodiments thereof and the respective advantages have already been correspondingly explained in relation to the sensor arrangement according to the invention.

In one preferred embodiment, a raw angle is formed for the respective sensor from a respective axial component and tangential component of the same sensor by means of an arc tangent function. The raw angle is then processed, preferably in the evaluation unit, to form the rotation angle. The corresponding procedure and its advantages have already been correspondingly explained above in relation to the raw angle or the raw angle module.

In one preferred embodiment, the raw angle is formed by means of an unweighted arc tangent function. As explained in detail above, it is therefore not necessary to intervene in the calculation of the actual arc tangent function, i.e. the expansion, explained above, with the factors (kx, ky) can be dispensed with.

In one preferred embodiment of the invention, at least one mean value is formed from at least two of the axial components and/or tangential components. Alternatively or additionally, the mean value is formed from determined raw angles, if they are present. The mean value is then processed, preferably in the evaluation unit, to form the rotation angle. The corresponding procedure has already been correspondingly explained above.

In one preferred embodiment, individual raw angles are formed for at least two of the sensors, wherein the positions (axial and/or radial and/or circumferential position) of the sensors are selected in such a way that the individual raw angles have an axially symmetrical profile in relation to an ideal angle straight line (determined rotation angle plotted against the actual rotation angle). The rotation angle is then determined by forming mean values of the two raw angles.

The corresponding procedure has already been correspondingly explained above. In particular, in this context an angular offset of 90° of the sensors with respect to the axis of rotation in the circumferential direction can be selected so that the favorable relationship, explained above, between the raw angles (symmetry with respect to an ideal straight line) occurs.

In one preferred embodiment, the profile of the determined rotation angle plotted against the actual rotation angle is optimized by means of an FEM analysis of the measuring field, at least at the location of at least one sensor. The optimization is carried out in particular in such a way that, by means of a rasterized FEM analysis of specifiable axial distances and radial distances and angular offsets, those which supply comparatively optimum linearity of the profile are selected.

Varying parameters of the arrangement, at least the axial distance and/or radial distance and/or circumferential position of the sensors, changes the profile of the actually determined rotation angle. According to the invention, the parameters are varied in such a way and until, within the scope of the corresponding variation (that is to say within the scope of the positioning possibilities which are considered, in particular a limited selection), a combination is found in which the deviation between the determined rotation angle and the actual rotation angle (in particular within all the tested positions) is minimized. In particular, in this context the corresponding variables are checked in a radial-axial plane of the axis of rotation in a grid shape with suitable grid intervals and a suitable number of grid points, said checking occurring at all the grid points, and the optimum grid point (radial distance/axial distance) for the positioning of the sensor is selected. In this context, the circumferential offset between the sensors is also varied. A person skilled in the art has a multiplicity of selection possibilities both for a corresponding optimization process and for a corresponding degree of deviation, which is to be optimized, between determined rotation angle and actual rotation angle. A person skilled in the art is able here to make a suitable selection for a specifically present sensor arrangement.

The term “can be specified” needs to be understood here as meaning in particular a technically practice-conform number, which is as small as possible but sufficient, of grid points which are to be examined, but which are positioned significantly densely or in technically appropriately graduated distances in a radial-axial circumferential range which appears correspondingly appropriate.

The corresponding optimization can then be carried out theoretically or on a computer; there is no need for tests or measurements for this.

Other features, effects and advantages of the invention can be found in the following description of a preferred exemplary embodiment of the invention as well as of the appended figures, in which, in each case in a schematic basic diagram:

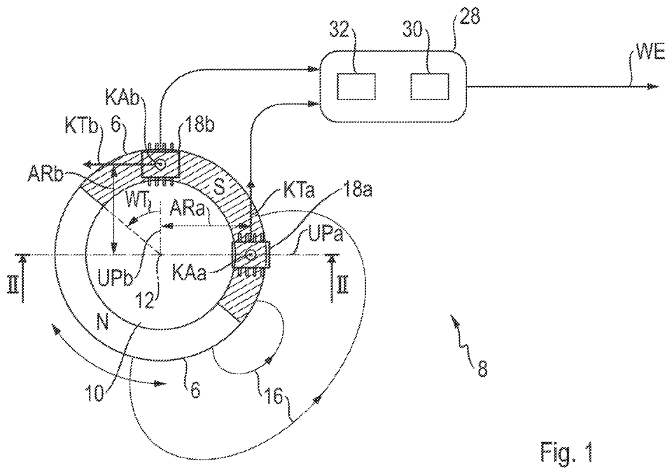

FIG. 1 shows a sensor arrangement according to the invention in a plan view and

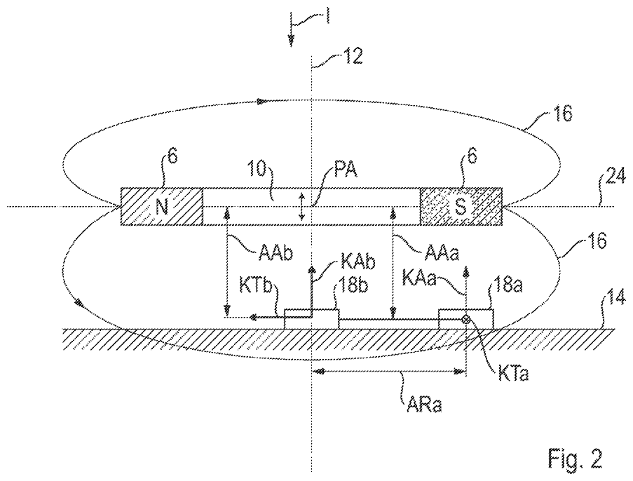

FIG. 2 shows it in a side view,

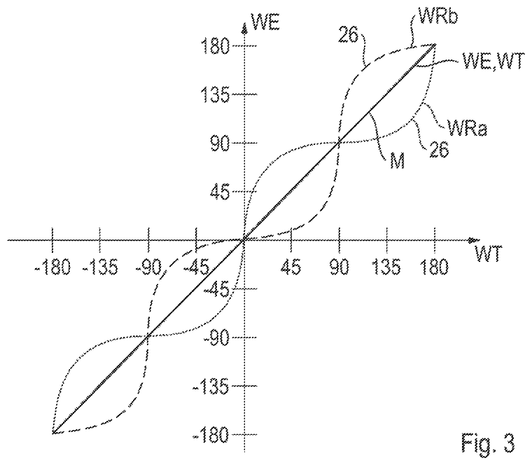

FIG. 3 shows the raw angles of the two sensors from FIGS. 1 and 2 as well as the actual rotation angle and the determined rotation angle, plotted against the actual rotation angle,

FIG. 4 shows a sensor arrangement according to the prior art, and

FIG. 5 shows the raw angle of the sensor from FIG. 4, plotted against the actual rotation angle according to the prior art.

FIG. 1 (plan view in the direction of the arrow I in FIG. 2) and FIG. 2 (section in the direction of the arrows II-II in FIG. 1) show a sensor arrangement 8 according to the invention. The latter serves to determine a (determined) rotation angle WE of a magnet 6 about an axis of rotation 12 relative to a base carrier 14. The determined rotation angle WE is intended to ideally correspond here to the actual rotation angle WT of the magnet 6 about the axis of rotation 12. The base carrier 14 and magnet 6 are part of the sensor arrangement 8 here. The magnet 6 can therefore rotate about the axis of rotation 12 (indicated by means of a double arrow) and is diametrically magnetized here with respect to the axis of rotation 12. The magnet 6 therefore generates a magnetic measuring field 16 which is indicated here only symbolically by field lines.

A first sensor 18a of the sensor arrangement 8 is arranged in a positionally fixed manner relative to the base carrier 14. Said sensor 18a serves to capture a first tangential component KTa and a first axial component KAa of the measuring field 16. The terms “axial”, “tangential” etc. are to be understood here as being with respect to the axis of rotation 12. The first sensor 18a is arranged here at a first circumferential position UPa with respect to the axis of rotation 12 and at a first radial distance ARa from the axis of rotation 12.

The sensor arrangement 8 also contains a second sensor 18b for capturing a second tangential component KTb and a second axial component KAb of the measuring field 16. The second sensor 18b is arranged at a second circumferential position UPb with respect to the axis of rotation 12 and at a second radial distance RAb with respect to the axis of rotation 12.

The sensor arrangement 8 also contains an evaluation unit 28 for determining the rotation angle WE. In the example, the evaluation unit 28 uses for this purpose both tangential components KTa,b and axial components KAa,b of the first sensor 18a and second sensor 18b, as will be explained further below.

Both sensors 18a,b are arranged in an offset manner, by a first and a second axial distance AAa,b, which are the same here, in relation to a central plane 24, lying transversely with respect to the axis of rotation 12, of the magnet 6 in the axial direction of the axis of rotation 12. Furthermore, both sensors 18a,b are at the same radial distance ARa,b in relation to the axis of rotation 12. The two circumferential positions UPa,b also enclose a right angle with respect to the axis of rotation 12 here.

The magnet 6 is also embodied to be rotationally symmetrical with respect to the axis of rotation 12, here as a ring magnet which is arranged concentrically with respect to the axis of rotation 12. Therefore, said ring magnet has a central opening 10, which serves as a feedthrough for cables (not illustrated) when the sensor is installed in an application (not illustrated), e.g. a shift lever of an automobile.

The axial position PA of the magnet 6 on the axis of rotation 12 is variable, i.e. the magnet 6 can move in the direction of the illustrated double arrow. The axial distances AAa,b change uniformly during such a movement.

The evaluation unit 28 contains a raw angle module 32. The latter serves to form a raw angle WRa,b for the respective sensor 18a,b from a respective axial component KAa,b and tangential component KTa,b of the same sensor 18a,b by means of an arc tangent function, which raw angle WRa,b is then processed to form the rotation angle WE.

The evaluation unit 28 also contains a mean value module 30. The latter serves to form a mean value M from the two determined raw angles WRa,b, which mean value M is then processed to form the rotation angle WE, or constitutes the determined rotation angle WE here.

FIG. 3 illustrates how the two raw angles WRa,b are easily determined by means of a pure arc tangent function, that is to say without the abovementioned factors kx, ky or with kx=ky=1, and therefore have a nonlinear profile 26 when plotted against the actual rotation angle WT. The deviations of the profiles 26 from the actual rotation angle WT are illustrated in a highly enlarged fashion in the example. In practice, they vary within the range of single-digit degrees, generally below 1°. The deviations from or distortions of the actual rotation angle WT are in each case basically positively and negatively sinusoidal.

However, the formation of mean values

$$WE = \frac{WRa + WRb}{2}$$

between the two raw angles WRa,b then yields the determined rotation angle WE on the ideal straight line which is described by the absolute rotation angle WT. Residual errors arise through nonlinearities of the overall system.

### LIST OF REFERENCE SYMBOLS

6 Magnet
8 Sensor arrangement
10 Opening
12 Axis of rotation
14 Base carrier
16 Measuring field
18a,b Sensor
24 Central plane
26 Profile
28 Evaluation unit
30 Mean value module
32 Raw angle module
100 Sensor arrangement
102 Sensor
104 Base carrier
106 Magnet
108 Axis of rotation
110 Measuring field
112 Evaluation unit
WT Rotation angle (actual)
WE Rotation angle (determined)
N North pole
S South pole
KAa,b Axial component
KTa,b Tangential component
AAa,b Axial distance
ARa,b Radial distance
UPa,b Circumferential position
M Mean value
PA Axial position
WRa,b Raw angle

1. A sensor arrangement for determining a rotation angle of a magnet about an axis of rotation relative to a base carrier, the sensor arrangement comprising:
the base carrier;
the magnet configured to rotate relative to the base carrier about the axis of rotation to generate a magnetic measuring field;
a first sensor positionally fixed relative to the base carrier and configured to capture a first tangential component and a first axial component of the measuring field with respect to the axis of rotation, wherein the first sensor is arranged at a first circumferential position with respect to the axis of rotation and at a first radial distance from the axis of rotation;
at least one second sensor configured to capture a second tangential component and a second axial component of the measuring field with respect to the axis of rotation and which is arranged at a second circumferential position with respect to the axis of rotation and at a second radial distance from the axis of rotation; and
an evaluation unit configured to determine the rotation angle from at least three of the first tangential component, the second tangential component, the first axial component, or the second axial component by means of an arc tangent function.

2. The sensor arrangement of claim 1, wherein:
at least one of the first sensor or the second sensor is arranged in a manner offset by an axial distance in relation to a central plane, lying transversely with respect to the axis of rotation of the magnet in the axial direction of the axis of rotation.

3. The sensor arrangement of claim 2, wherein:
at least two of the first sensor or the second sensor are arranged at at least one of a same axial distance or a same radial distance from the axis of rotation.

4. The sensor arrangement of claim 1, wherein:
the first circumferential position and the first circumferential position are offset at right angles to one another.

5. The sensor arrangement of claim 1, wherein:
the magnet is rotationally symmetrical with respect to the axis of rotation.

6. The sensor arrangement of claim 5, wherein:
the magnet is a ring magnet which is arranged concentrically with respect to the axis of rotation.

7. The sensor arrangement of claim 1, wherein:
an axial position of the magnet along the axis of rotation is variable with respect to the base carrier.

8. The sensor arrangement of claim 1, wherein:
the evaluation unit comprises a raw angle module configured to form a raw angle for a respective sensor from a respective axial component and tangential component of the same sensor by means of an arc tangent function,
wherein the evaluation unit is further configured to determine the rotation angle by processing the raw angle.

9. The sensor arrangement of claim 1, wherein:
the evaluation unit comprises a mean value module configured to form a mean value from at least two of the first axial component, the second axial component, the first tangential component, or the second tangential component,
wherein the evaluation unit is further configured to determine the rotation angle by processing the mean value.

10. A method for determining a rotation angle of a magnet about an axis of rotation relative to a base carrier, the method comprising:
rotating the magnet relative to the base carrier about the axis of rotation to generate a magnetic measuring field;
capturing, by a first sensor, a first tangential component and a first axial component of the measuring field with respect to the axis of rotation, wherein the first sensors is positionally fixed relative to the base carrier and is arranged at a first circumferential position with respect to the axis of rotation and at a first radial distance from the axis of rotation;
capturing, by a second sensor, a second tangential component and a second axial component of the measuring field with respect to the axis of rotation, wherein the first sensors is arranged at a second circumferential position with respect to the axis of rotation and at a second radial distance from the axis of rotation;
determining, by an evaluation unit, the rotation angle from at least three of the first tangential component, the second tangential component, the first axial component, or the second axial component by means of an arc tangent function.

11. The method of claim 10, further comprising:
forming a raw angle for a respective sensor from a respective axial component and tangential component of the same sensor by means of an arc tangent function; and
processing, by the evaluation unit, the raw angle to form the rotation angle.

12. The method of claim 11, further comprising:
forming the raw angle is formed by means of an unweighted arc tangent function.

13. The method of claim 10, further comprising:
forming at least one mean value from at least two of the first axial component, the second axial component, the first tangential component, or the second tangential component; and
processing, by the evaluation unit, the mean value to form the rotation angle.

14. The method of claim 10, further comprising:
forming individual raw angles for at least the first sensor and the second sensor, wherein the positions of the first sensor and the second sensor are selected in such a way that the individual raw angles have an axially symmetrical profile in relation to an ideal angle straight line, and the rotation angle is determined by forming mean values of the two raw angles.

15. The method of claim 10, further comprising:
optimizing a profile of the determined rotation angle plotted against the actual rotation angle by means of an FEM analysis of the measuring field at the location of the sensor.

16. The method of claim 11, further comprising:
forming at least one mean value from at least two of the first axial component, the second axial component, the first tangential component, the second tangential component, or the raw angle; and
processing, by the evaluation unit, the mean value to form the rotation angle.

17. The sensor arrangement of claim 8, wherein:
the evaluation unit comprises a mean value module configured to form a mean value from at least two of the first axial component, the second axial component, the first tangential component, the second tangential component, or the raw angle,
wherein the evaluation unit is further configured to determine the rotation angle by processing the mean value.
